(19) United States
(12) Patent Application Publication
(10) Pub. No.: US 2012/0188097 A1
(43) Pub. Date: Jul. 26, 2012

(54) SYSTEM AND METHOD FOR COOPERATIVE VEHICLE ADAPTATION

(75) Inventors: David C. Brillhart, Orlando, FL (US); Christopher J. Dawson, Arlington, VA (US); Nicholas J. Karels, Aurora, IL (US); Michael D. Kendzierski, New York, NY (US); James W. Seaman, Falls Church, VA (US)

(73) Assignee: International Business Machines Corporation, Armonk, NY (US)

(21) Appl. No.: 13/014,462

(22) Filed: Jan. 26, 2011

(51) Int. Cl. G08G 1/00

(52) U.S. Cl. 340/902

(57) ABSTRACT

Techniques for cooperative vehicle adaptation are disclosed. A method according to one embodiment includes the steps of receiving an indicator of a first vehicle, receiving an indicator of a second vehicle when the second vehicle is within a geographic region of the first vehicle, analyzing the indicator of the first vehicle and the indicator of the second vehicle, and determining an external condition based on the analyzed indicators. The indicators may be fault indicators or internal condition indicators.

### BACKGROUND

Embodiments of the inventive subject matter generally relate to the field of vehicle computers, and more particularly, to systems and methods for corroborative vehicle adaptation to external conditions.

Modern vehicles typically have computer systems that monitor and detect failures in various components of the vehicle. For example, such a computer system can monitor the exhaust, the speed of the vehicle, and the fuel injection system. When the computer system detects a problem with one of these components, the computer system typically lights an indicator light on the dashboard of the vehicle. The indicator light alerts the operator that there is a problem with the vehicle, and the operator can then decide how to respond to the problem. Computerized systems of modern vehicles can detect problems internal to the vehicle. However, such systems typically do not detect conditions external to the vehicle, where the external conditions can cause internal problems for the vehicle.

### SUMMARY

According to one illustrative embodiment, a method for determining conditions external to one or more vehicles in a geographic region. The method includes receiving, in a corroborative adaptive controller, a first group of one or more indicators, wherein the first group of indicators indicates information about one or more subsystems of a first vehicle. The method also includes receiving, in the corroborative adaptive controller, a second group of one or more indicators, wherein the second group of indicators indicates information about one or more subsystems of a second vehicle. The method also includes determining, by the corroborative adaptive controller, based on the first group of indicators and the second group of indicators, that there is an external condition in a geographic region including the first vehicle and the second vehicle, where the external condition can affect performance of the first vehicle and the second vehicle.

According to another illustrative embodiment, a computer program product for determining conditions external to one or more vehicles. The computer program product can include one or more computer-readable, tangible storage devices. The computer program product can include program instructions, stored on at least one of the one or more storage devices, to receive a first group of one or more indicators, wherein the first group of indicators indicates information about one or more subsystems of a first vehicle. The computer program product can include program instructions, stored on at least one of the one or more storage devices, to receive a second group of one or more indicators, wherein the second group of indicators indicates information about one or more subsystems of a second vehicle, wherein the first and second vehicles are located within a geographic region. The computer program product can include program instructions, stored on at least one of the one or more storage devices, to determine, based on the first group of indicators and the second group of indicators, that there is an external condition, in the geographic region, that can affect performance of the first vehicle and the second vehicle.

According to another illustrative embodiment, a computer system for determining conditions external to one or more vehicles in a geographic region. The computer system can include one or more processors, one or more computer-readable memories and one or more computer-readable, tangible storage devices. The computer system can also include program instructions, stored on at least one of the one or more storage devices for execution by at least one of the one or more processors via at least one of the one or more memories, to receive a first group of one or more indicators, wherein the first group of indicators indicate information about one or more subsystems of a first vehicle. The computer system can also include program instructions, stored on at least one of the one or more storage devices for execution by at least one of the one or more processors via at least one of the one or more memories, to receive a second group of one or more indicators, wherein the second group of indicators indicate information about one or more subsystems of a second vehicle, wherein the first and second vehicles are located within a geographic region. The computer system can also include program instructions, stored on at least one of the one or more storage devices for execution by at least one of the one or more processors via at least one of the one or more memories, to determine, based on the first group of indicators and the second group of indicators, that there is an external condition that can affect performance of the first vehicle and the second vehicle.

### BRIEF DESCRIPTION OF THE SEVERAL VIEWS OF THE DRAWINGS

The illustrative embodiments may be better understood, and numerous objects, features, and advantages made apparent to those skilled in the art by referencing the accompanying drawings.

FIG. 1 depicts a block diagram of a system for vehicle adaptation according to an illustrative embodiment of the invention.

FIG. 2 depicts a block diagram of an embodiment of the corroborative adaptive controller according to an illustrative embodiment of the invention.

FIG. 3 depicts a schematic diagram of a transit system according to an illustrative embodiment of the invention.

FIG. 4 depicts a schematic diagram of a transit system according to an illustrative embodiment of the invention.

FIG. 5 depicts a flow diagram of a method for cooperative vehicle adaptation according to an illustrative embodiment of the invention.

FIG. 6 depicts an example computer system that may embody a cooperative adaptive controller according to an illustrative embodiment of the invention.

### DETAILED DESCRIPTION

This document describes techniques for corroborative vehicle adaptation. In some embodiments, vehicle systems in a common geographic region communicate indicators of faults, internal conditions, etc. with other vehicles and/or communication ports positioned in a transit system. In response to the indicators, the vehicle systems analyze external conditions, and send alerts about the external conditions.

The description that follows includes exemplary systems, methods, techniques, instruction sequences and computer program products that embody techniques of the present inventive subject matter. However, it is understood that the described embodiments may be practiced without these specific details or in different sequences or by omitting or rearranging the steps. In other instances, well-known instruction instances, protocols, structures and techniques have not been shown in detail in order not to obfuscate the description.

This description of the embodiments is divided into five sections. The first section presents an example system architecture, the second section describes example methods of operation, the third section discusses system operations, the fourth section presents hardware and an operating environment, and the fifth section provides general comments.

### System Architecture

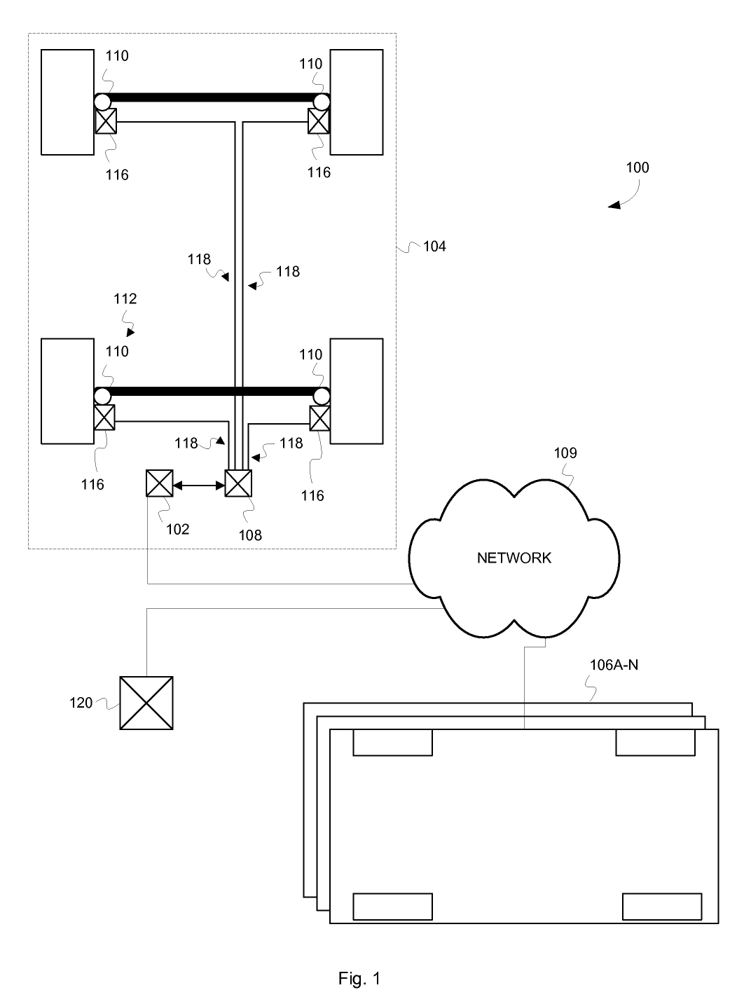

FIG. 1 depicts a block diagram of a system for vehicle adaptation according to an illustrative embodiment of the invention. The system for vehicle adaptation 100 includes one or more corroborative adaptive controllers 102 and 120 capable of analyzing one or more indicators experienced by two or more vehicles within a geographic region. For exemplary purposes, FIG. 1 shows a first vehicle 104 and a plurality of additional vehicles 106A-N, where “A” represents the first vehicle of the plurality of additional vehicles, and “N” represents a total number of the plurality of additional vehicles. While in the illustrative embodiment of FIG. 1, vehicle 104 includes corroborative adaptive controller 102, in other illustrative embodiments, any of vehicles 106A-N may include corroborative adaptive controller 102. In one illustrative embodiment, corroborative adaptive controller 102 may be at a remote location and may be capable of sending data from and receiving data to vehicles 104 and 106A-N. In FIG. 1, corroborative adaptive controller 120 is a remote corroborative adapter controller located remotely of vehicles 104 and 106A-N. Thus, corroborative adaptive controllers 102 and 120 may work in a peer-to-peer fashion or in a client-server fashion.

Vehicle 104 may have a control system 108 for controlling and monitoring various functions of vehicle 104. Each of vehicles 106A-N may also have a control system (not shown) similar to control system 108 for controlling and monitoring functions of the respective vehicle. A communication network 109 may allow communication between vehicles 104 and 106A-N and/or corroborative adaptive controller(s) 120.

Vehicles 104 and 106A-N may be any vehicles capable of traveling on a transit system. Vehicles 104 and 106A-N as shown and described herein are automobiles; however, it should be appreciated that each of vehicles 104 and 106A-N may be any suitable vehicle including, but not limited to a car, truck, motorcycle, scooter, tractor trailer, dump truck, construction vehicle, etc.

Vehicles 104 and 106A-N may include several vehicle subsystems that work together to allow vehicles 104 and 106A-N to operate. In FIG. 1, vehicle 104 has vehicle subsystem 112. Examples of vehicle subsystems, such as vehicle subsystem 112, are subsystems for monitoring engine oil level, engine temperature, brake system pressure, transmission status, tire pressure, suspension system status, or any other vehicle subsystem in a vehicle. Each of vehicles 104 and 106A-N may include any suitable number and type of vehicle subsystems. In FIG. 1, vehicle subsystem 112 of vehicle 114 is a suspension system.

Each subsystem of vehicles 104 and 106A-N can communicate a subsystem status of their respective vehicle subsystems, and these communications may occur independently or dependently of other subsystems—depending on the particular subsystems. Sensors may detect internal conditions and faults of the various vehicle subsystems. For example, vehicle subsystem 112 of vehicle 114 has sensors 116A-D. Sensors 116A-D monitor the internal conditions and faults of the suspension system, i.e. vehicle subsystem 112. Sensors 116A-D may be any type of sensor, such as electronic, pneumatic, electromagnetic, combinations thereof, and the like.

Control system 108 controls vehicle subsystem 112 based on signals received from vehicle subsystem 112. Control system 108 can receive the signals from sensors 116A-D of vehicle subsystem 112. Vehicles 106A-N also have control systems (not shown) similar to control system 108 and subsystems (not shown) similar to vehicle subsystem 112. Control system 108 may automatically monitor and adjust the operation of each of the vehicle subsystems of vehicle 104, such as vehicle subsystem 112, during normal operation of vehicle 104. In the normal operation of vehicle 104, control system 108 optimizes the operation of the vehicle 104's various vehicle subsystems, such as vehicle subsystem 112, based on signals received from the vehicle subsystems.

Control system 108 may detect faults of vehicle 104. For example, control system 108 may detect faults of vehicle subsystem 112, i.e., the suspension system. Sensors 116A-D send signals regarding the operation of vehicle subsystem 112 to control system 108 via communication paths 118A-D, respectively. Sensors 116A-D may communicate by means including but not limited to a wire line, a gas line, a line for pneumatic fluid, an optical line, a cellular/mobile connection, or a wireless connection. In FIG. 1, control system 108 receives signals from sensors 116A-D regarding vehicle subsystem 112. Sensors 116A-D may communicate the pressure or movement of shock absorbers 110A-D, respectively, for example, to control system 108. If the pressure of one of shock absorbers 110A-D is too low or too high (outside the normal operating pressure), control system 108 may detect the abnormal operating condition, determine the abnormal operating condition is a fault, and notify the operator of vehicle 104 that shock replacement is necessary.

Control system 108 may also detect conditions internal to vehicle 104 that are normal to vehicle operation. That is, vehicles have internal conditions that may change without being outside of normal operating states. In FIG. 1, control system 108 receives signals from sensors 116A-D regarding the conditions of shock absorbers 110A-D of the suspension system, i.e. vehicle subsystem 112 of vehicle 104. When the signals indicate that vehicle subsystem 112 is within normal operating conditions, controller 108 may leave vehicle subsystem 112 unchanged because there are no abnormal conditions or faults. Alternatively, control system 108 may reconfigure vehicle subsystem 112, such as by changing the pressure in shock absorbers 110A-D from a pressure adequate for highway driving to a pressure adequate for off-road driving. In this scenario, control system 108 controls and adjusts the operating configuration of shock absorbers 110A-D of vehicle subsystem 112, without the presence of faults.

Because each of vehicles 106A-N has vehicle subsystems and a control system like vehicle 104, corroborative adaptive controller 102 receives indicators such as fault indicators, internal condition indicators, or both, experienced by vehicle 104 and vehicles 106A-N. A fault indicator may be any signal, transmitted by one or more sensors, such as sensors 116A-D, indicating that a particular vehicle subsystem, such as vehicle subsystem 112, is experiencing an operational state that is outside of its normal operational state. For example, a fault indicator may indicate that the vehicle is at an abnormal inclination, the steering system is out of alignment, an air intake is blocked or otherwise restricted, exhaust is below emissions standards, etc. In some embodiments, a fault indicator can indicate a geographic location. Corroborative adaptive controller 102 can analyze fault indicators of vehicles 104 and 106A-N.

An internal condition indicator may be any signal, transmitted by one or more sensors, such as sensors 116A-D, indicating that a particular vehicle subsystem, such as vehicle subsystem 112, is operating within its normal operational state without failure, but is not operating at a default state. For example, an internal condition indicator may indicate the pressure in shock absorbers 110C and 110D is higher than a default pressure. Corroborative adaptive controller 102 can analyze internal condition indicators of vehicles 104 and 106A-N.

Corroborative adaptive controller 102 analyzes indicators of vehicles 104 and 106A-N and determines one or more external conditions. That is, corroborative adaptive controller 102 analyzes indicators and determines a condition, external to vehicles 104 and 106A-N, which is causing the indicators. For example, based on such an analysis, corroborative adaptive controller 102 may determine, based on fault indicators from vehicles 104 and 106A-N, that there is a road hazard (e.g., a pothole) at a geographic location on a road. In another example, based on such an analysis, corroborative adaptive controller 102 may determine, based on internal condition indicators from vehicles 104 and 106A-N, that a strong wind is blowing in a certain direction in a geographic region. In some embodiments, other situations exist where corroborative adaptive controller 102 can analyze both fault indicators and internal condition indicators and determine an external condition based on such an analysis.

Corroborative adaptive controller 102 is shown in FIG. 1 as separate from control system 108; however, embodiments of corroborative adaptive controller 102 may be partially or fully integrated with control system 108. Likewise, vehicle subsystem 112 (or any other suitable subsystem) may be directly connected to corroborative adaptive controller 102. Corroborative adaptive controller 102 can be configured to interpret signals from vehicle subsystem 112 without a need for connecting corroborative adaptive controller 102 to control system 108.

Corroborative adaptive controller 102 may determine an error status associated with vehicle subsystems of vehicles 104 and 106A-N. If indicators of vehicle 104 are similar to indicators of vehicles 106A-N, then the indicators of vehicles 104 and 106A-N may be a result of an external environmental condition experienced by all of vehicles 104 and 106A-N. Therefore, the error status associated with the vehicle subsystems may indicate that there is no subsystem failure. If the indicators generated by vehicle 104 are dissimilar to those of vehicles 106A-N, there may be a vehicle subsystem failure in vehicle 104. In this event, the error status would indicate that a vehicle subsystem of vehicle 104 has failed.

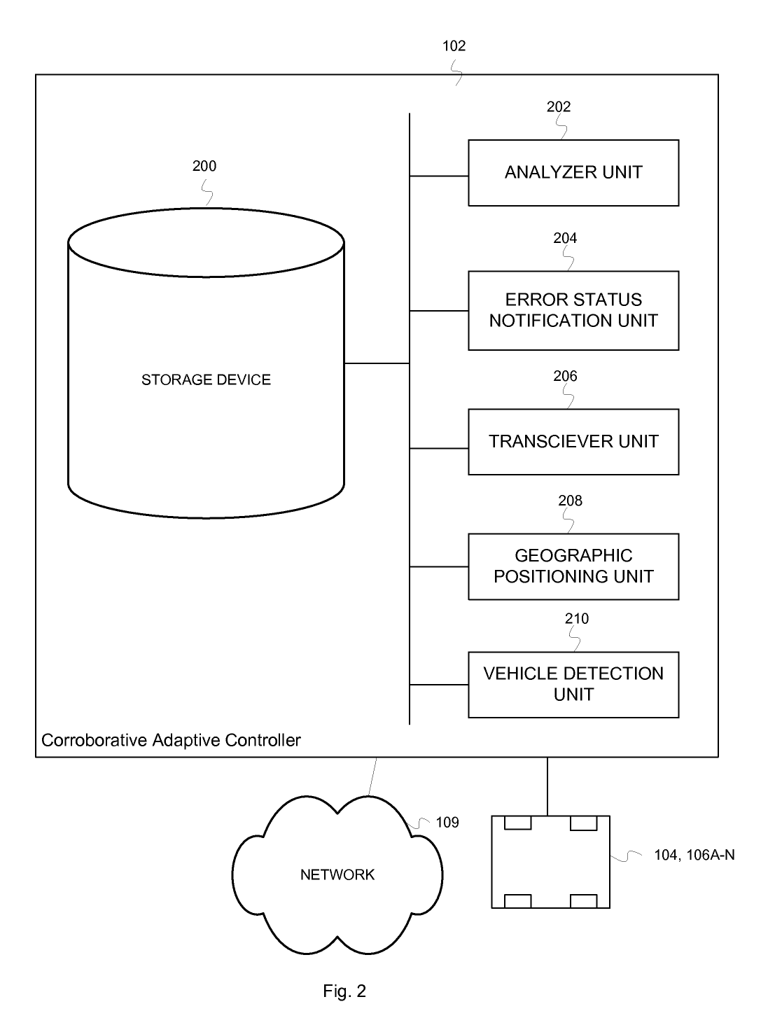

FIG. 2 shows a block diagram of corroborative adaptive controller 102 according to an illustrative embodiment of the invention. Corroborative adaptive controller 102 may include storage device 200, analyzer unit 202, error status notification unit 204, transceiver unit 206, geographic positioning unit 208, and vehicle detection unit 210.

Transceiver unit 206 allows corroborative adaptive controller 102 to communicate with the various subsystems of vehicle 104, vehicles 106A-N, operators of vehicles 104 an 106A-N, other remote systems (such as a transit system), or remote corroborative adaptive controller 120 shown in FIG. 1.

Analyzer unit 202 analyzes fault indicators and internal condition indicators received from one or more of vehicles 104 and 106A-N. After analyzing fault indicators and/or internal condition indicators, analyzer unit 202 determines an error status of the vehicle subsystem(s), such as vehicle subsystem 112. Analyzer unit 202 of corroborative adaptive controller 102 may determine the error status using any number of suitable methods. For example, analyzer unit 202 may determine the error status by calculating a percentage of conditions similar to a fault indicator. If the percentage of the conditions similar to the fault indicator reaches a threshold percentage, for example 80%, then the fault indicator may be logged as an erroneous fault indicator. For example, if 80% of vehicles in a geographic area exhibit a similar fault, corroborative adaptive controller 102 may determine that the fault indicator is erroneous. The fault indicator may be the result of shock absorbers of the vehicle from which the fault indicator was received handling a very large pothole, and not a true fault. If the percentage falls below the threshold percentage, the error status may be logged as a vehicle subsystem failure. It should be appreciated that any suitable percentage may be used for the threshold percentage. Further, it should be appreciated that the percentage method is only one possible method of determining the error status and that several other methods may be used including, but not limited to, a consensus method, comparing closely related conditions, etc.

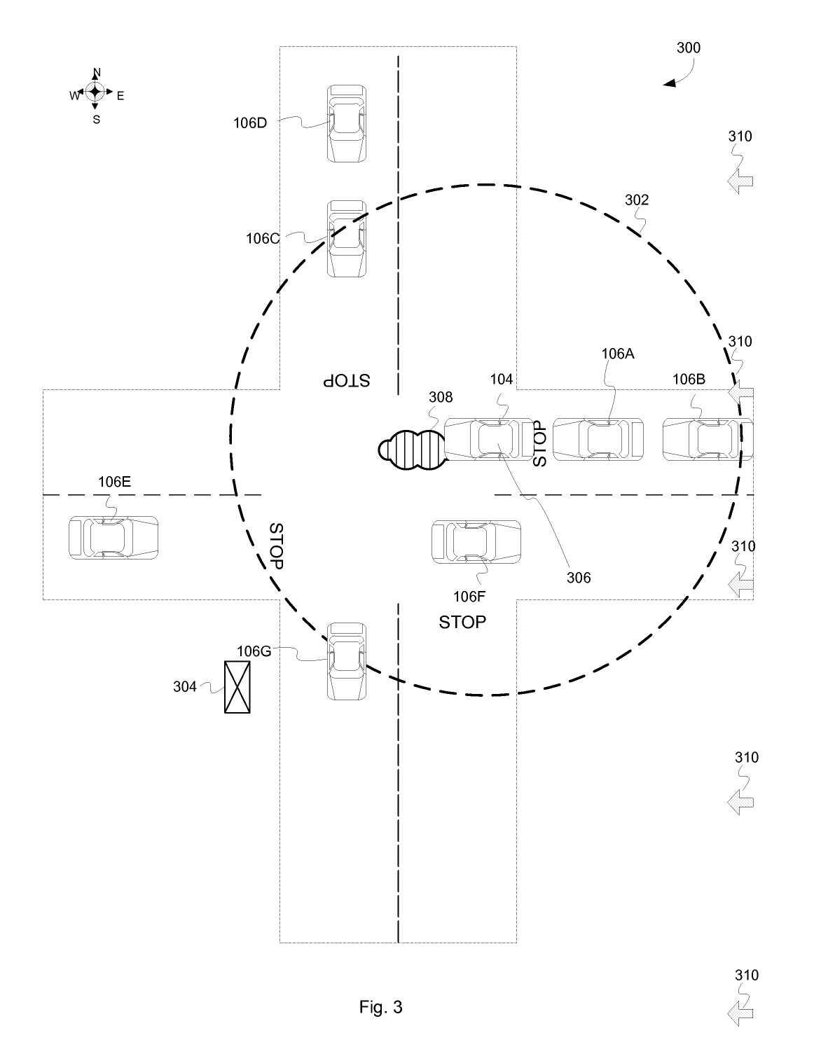

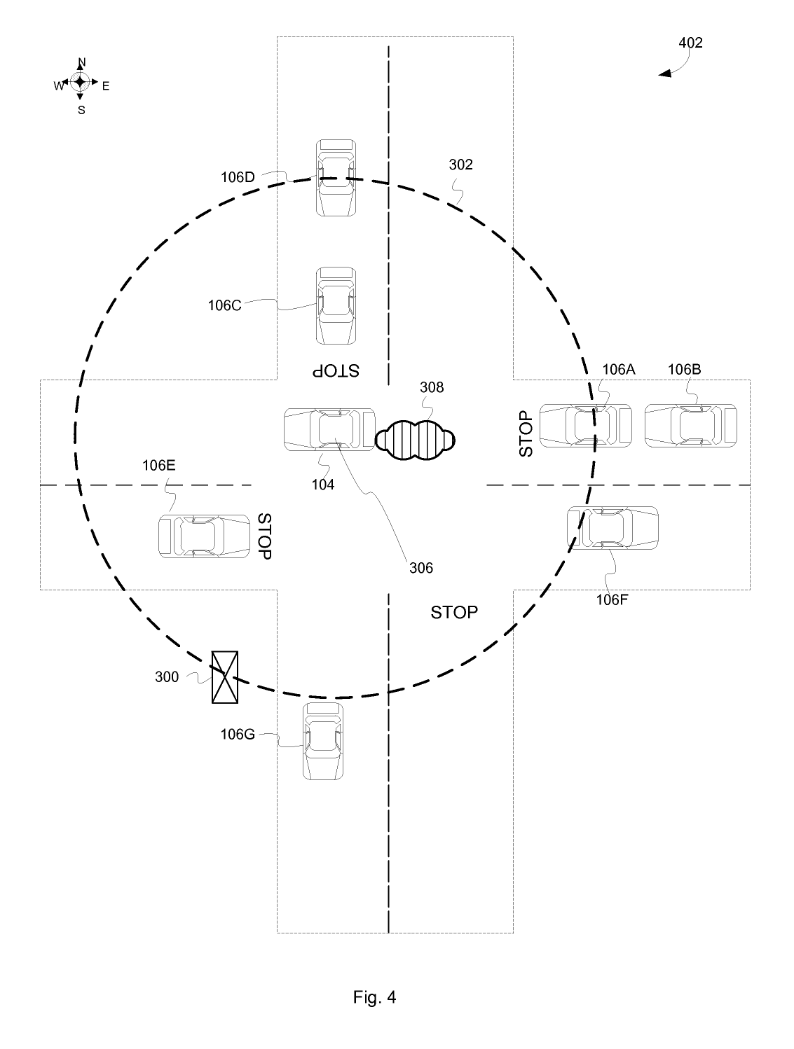

Also after analyzing fault indicators and/or internal condition indicators, analyzer unit 202 determines whether the indicators were caused by an external condition (e.g., wind, road hazards, etc.). For example, analyzer unit 202 may determine that the external condition is a pothole or wind, as is discussed in FIG. 3 below. To determine the external condition, analyzer unit 202 may use any number of algorithms and methods. For example, analyzer unit 202 may determine the external condition by calculating a percentage of indicators received from vehicles 106A-N that are similar to an indicator received from vehicle 104. If the percentage of similar indicators from vehicles 106A-N reaches a threshold percentage, for example 80%, then the indicator of vehicle 104 may be logged as a certain external condition (e.g., wind, potholes, rough pavement, etc.). Any suitable percentage may be used for the threshold percentage. Furthermore, methods different from the percentage method may be used, such as a consensus method, comparing closely related conditions, etc. Examples of such methods are discussed vis-à-vis FIGS. 3 and 4.

Error status notification unit 204 assigns an error status to a particular vehicle subsystem based on an analysis performed by analyzer unit 202. Error status notification unit 204 may further relay the error status to control system 108 of vehicle 104 or to a control system of one of vehicles 106A-N.

Storage device 200 may store data, such as fault indicators and internal condition indicators, experienced by vehicles 104 and 106A-N, the geographic location and region where the indicators occurred, and the time and duration in which the indicators occurred. Storage device 200 may also retain a history of indicators and categorize the history according to various parameters such as frequency of occurrences, duration of occurrences, and geographic location.

Geographic positioning unit 208 determines a geographic location of vehicle 104. In some embodiments, geographic positioning unit 208 determines geographic location upon the occurrence of an indicator. In some embodiments, geographic positioning unit 208 may determine a geographic location of the occurrence of an indicator without determining the geographic location of vehicle 104. Geographic positioning unit 208 determines a geographic region based on the geographic location. The geographic region may have any size and shape. Geographic locations can be determined by any suitable technology and method, including but not limited to global position systems (GPS) and triangulation.

Vehicle detection unit 210 detects vehicles located proximate to the geographic location, located within the geographic region, approaching the geographic region, or approaching the geographic location.

If analyzer unit 202 determines that a vehicle subsystem failure has occurred, error status notification unit 204 may alert control system 108 of vehicle 104. Control system 108 may alert the operator of vehicle 104 that the vehicle subsystem has failed by issuing an alert. Further, control system 108 may alert the operator when indicators experienced by vehicles 106A-N are similar to an indicator of vehicle 104.

If analyzer unit 202 determines an external condition, transceiver unit 206 may send an alert to control system 108 (which notifies a transportation authority), or transceiver unit 206 may alert a transportation authority of the external condition.

The alerts may be any suitable alert, including illuminating dashboard indicator lights, an audio notice, a text message on a display in the vehicle, an email to the operator or the manufacturer, a communication to the manufacturer, a text message to a personal digital assistant, etc. Furthermore, corroborative adaptive controller 102 may forgo alerting control system 108 about the vehicle subsystem failure and relay the information directly to the operator.

Corroborative adaptive controller 102 may be included in vehicle 104 before the first sale of vehicle 104. Further, corroborative adaptive controller 102 may be added to vehicle 104 after the first sale of vehicle 104 (e.g., in after-market form).

Corroborative adaptive controller 102 may operate according to peer-to-peer or client-server models. When operating according to the client-server model, corroborative adaptive controller 102 residing in vehicle 104 and corroborative adaptive controllers in vehicles 106A-N may not include all the components shown in FIG. 2, for example, vehicle detection unit 210 and error status notification unit 204. Conversely, one or more land-based corroborative adaptive controllers may include analyzer units and error status notification units, such as analyzer unit 202 and error status notification unit 204 of corroborative adaptive controller 102, respectively.

### Methods of Operation

FIG. 3 depicts a schematic diagram of a transit system according to an illustrative embodiment of the invention. FIG. 3 shows transit system 300 at a point in time. Transit system 300 includes a four-way-stop intersection with vehicles 104, 106A, 106B, 106C, 106D, 106E, 106F, and 106G of FIG. 1. In FIG. 3, vehicle 104 has left a stop, moving westward toward pothole 308. After encountering pothole 308, vehicle 104's sensors 116A-D (associated the suspension system's shock absorbers 110A-D) send indicators to control system 108, where the indicators indicate that pressure in shock absorbers 110A-D is changing rapidly in and out of normal operating pressures. The indicators include internal condition indicators indicating changes in shock absorber pressure, and fault indicators indicating abnormal shock absorber pressure.

Geographic positioning unit 208 shown in FIG. 2 of corroborative adaptive controller 102 of vehicle 104 determines geographic location 306 of vehicle 104. Geographic positioning unit 208 determines geographic region 302 based on geographic location 306. In FIG. 3, geographic region 302 is shown as a circle with dashed lines; however, it should be appreciated that in other illustrative embodiments, geographic region 302 can be of any size and shape. Moreover, in other illustrative embodiments, geographic region 302 can be determined relative to fixed terrestrial communication ports, such as port 304 in FIG. 3, instead of vehicles. Furthermore, in other illustrative embodiments, geographic region 302 can be determined by multiple communication ports, multiple vehicles, or a combination of single or multiple communication ports and vehicles 104 and 106A-G.

Transceiver unit 206 shown in FIG. 2 of corroborative adaptive controller 102 of vehicle 104 receives the indicators and geographic region 302. In some embodiments, indicators include geographic information. Transceiver unit 206 communicates the indicators to vehicles 106A, B, C, F, and G in geographic region 302. At the point in time shown in FIG. 3, vehicles 106A, B, C, F, and G have not encountered pothole 308, so vehicles 106A, B, C, F, and G have not generated and transmitted similar indicators.

Analyzer unit 202 shown in FIG. 2 of corroborative adaptive controller 102 of vehicle 104 analyzes the fault indicators and internal condition indicators, and determines whether the indicators are caused by an external condition. In FIG. 3, analyzer unit 202 determines that the external condition is pothole 308. Analyzer unit 202 can determine external conditions using any number of methods. For example, analyzer unit 202 may determine the existence of pothole 308 by recognizing rapid changes in shock absorber pressure in suspension systems of multiple vehicles. For rapid changes in pressure of the suspension systems, indicators received from the multiple vehicles may be either indicators of faults or indicators of internal conditions. Analyzer unit 202 can determine other external conditions, such as various road conditions, wind 310, etc. In some instances, analyzer unit 202 may detect a strong wind by recognizing low rear shock absorber pressures of vehicles 104, 106A, 106B, and by recognizing high shock absorber pressures in the front of the vehicle 106F. In determining wind 310 as the external condition, the indicators may be internal condition indicators of vehicles 104, 106A, 106B, and 106F.

In FIG. 3, vehicles 106D and E are not located in geographic region 302 of vehicle 104. In other embodiments of larger or differently-shaped geographic regions it is possible that a different combination of vehicles 106A-G would be within the geographic region 302 of vehicle 104.

In some embodiments, the vehicles may store indicators from previous journeys, such as a journey over pothole 308. Analyzer unit 202 may check for stored indicators in storage device 200. If stored indicators are available in storage device 200, analyzer unit 202 may analyze the stored indicators along with indicators of vehicle 104, in the scenario shown in FIG. 3. Vehicle 104 may store indicators in storage device 200, and the indicators may be stored with or without timestamps.

Similarly, a remote corroborative adaptive controller, such as corroborative adaptive controller 120, may store indicators from previous journeys. Analyzer unit 202 may also analyze indicators stored on a remote corroborative adaptive controller, such as corroborative adaptive controller 120. In some embodiments, transceiver unit 206 may receive the indicators from corroborative adaptive controller 120 through port 304. Alternatively, transceiver unit 206 may send indicators to corroborative adaptive controller 120 through port 304, and corroborative adaptive controller 120 may analyze and even store indicators of vehicle 104 with other stored indicators of other vehicles.

FIG. 4 depicts a schematic diagram of a transit system according to an illustrative embodiment of the invention. More specifically, FIG. 4 shows the system of FIG. 3 at a later point in time. In FIG. 4, vehicle 104 has moved across pothole 308, and geographic location 306 and geographic region 302 have changed. As noted above, the vehicles share indicators with others in a geographic region. Thus, after vehicle 104 hit pothole 308, vehicle subsystem 112 of vehicle 104 generates indicators, and vehicle 104 transmits the indicators to vehicles 106 A, C, D, & E. In turn, vehicles 106 A, C, D, & E receive the indicators generated by vehicle subsystem 112 of vehicle 104, and vehicles 106 A, C, D, & E analyze those indicators. In some instances, vehicles 104 and 106 A, C, D, & E exchange other indicators, such as indicators generated when driving over the pot hole 308 earlier in time. In some instances, land-based components (e.g., port 304) store and transmit indicators from earlier in time.

After traveling over pothole 308, corroborative adaptive controller 102 of vehicle 104 receives one or more indicators from vehicle subsystem 112 and/or other vehicles. In turn, in FIG. 4, analyzing unit 202 of corroborative adaptive controller 102 of vehicle 104 determines that pothole 308 is an external condition. Detection unit 210 of corroborative adaptive controller 102 of vehicle 104 detects vehicles within geographic region 302, at some point in time during the occurrence of indicators of vehicle 104. In some embodiments, vehicle detection unit 210 may detect that vehicles 106A and 106B are approaching pothole 308 (or other external condition), or otherwise approaching the geographic location 306 associated with the indicators.

After corroborative adaptive controller 102 of vehicle 104 determines an external condition (e.g., pothole 308), transceiver unit 206 of corroborative adaptive controller 102 of vehicle 104 can send an alert of the external condition (or the “raw” indicators) to vehicles within the geographic region 302. The alert can be an external condition indicator. For example, vehicle 104 sends vehicle 106A an external condition indicator indicating the location of the pot hole 308. In some embodiments, vehicle 104 may send the external condition indicator to vehicles approaching the geographic location 306. Furthermore, transceiver unit 206 of corroborative adaptive controller 102 of vehicle 104 may send the external condition indicator to land-based components, such as communication port 304. A remotely-located land-based corroborative adaptive controller, such as corroborative adaptive controller 120 shown in FIG. 1, may receive the external condition indicator over a network, and send an alert to vehicles within geographic region 302 or other geographic regions.

In FIG. 4, the transceiver unit 202 of corroborative adaptive controller 102 of vehicle 104 or the transceiver unit of a remotely located corroborative adaptive controller, such as corroborative adaptive controller 120, can send an alert to vehicles 106A and B regarding pothole 308. The alert may include instructions to change lanes in order to avoid pothole 308.

### System Operations

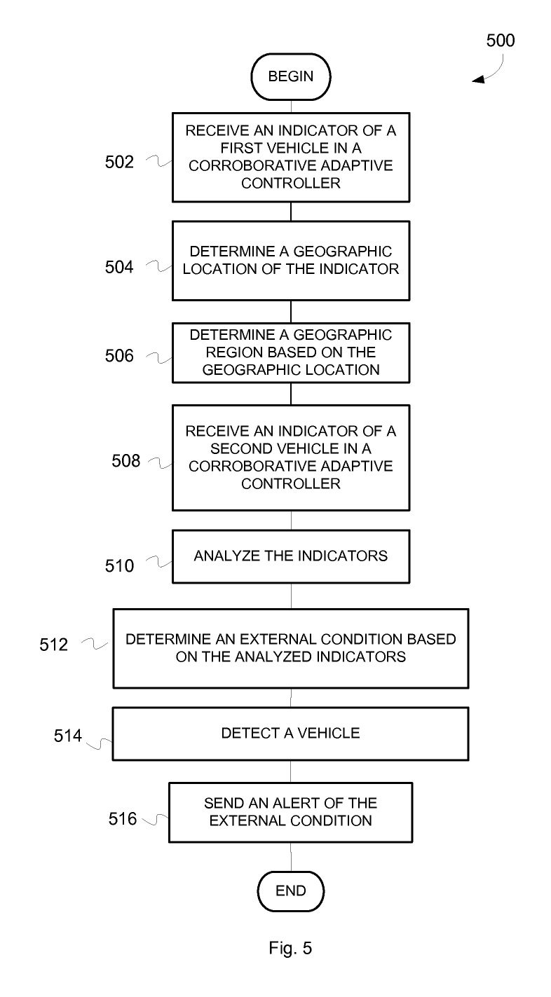

FIG. 5 depicts a flow diagram of a method for cooperative vehicle adaptation according to an illustrative embodiment of the invention. The method 500 commences at block 502. At block 502, a first vehicle's subsystem generates an indicator and sends the indicator to a corroborative adaptive controller, such as cooperative adaptive controller 102 or cooperative adapter controller 120 of FIG. 1. For example, an indicator of vehicle 104 is received in corroborative adaptive controller 102. Flow then proceeds to block 504.

At block 504, a geographic location is determined for the indicator. For example, geographic location 306 is determined for the indicator of vehicle 104. Flow then proceeds to block 506.

At block 506, a geographic region is determined based on the geographic location of the indicator of the first vehicle. For example, geographic region 302 is determined based on geographic location 306 of the indicator of vehicle 104. Flow then proceeds to block 508.

At block 508, the corroborative adaptive controller receives an indicator from a second vehicle. For example, corroborative adaptive controller 102 of vehicle 104 receives an indicator from vehicle 106A. Flow then proceeds to block 510.

At block 510, the cooperative adaptive controller analyzes the indicators of the first vehicle and the second vehicle. For example, cooperative adaptive controller 102 analyzes the indicator of vehicle 104 and the indicator of vehicle 106A (see FIG. 3). Embodiments work with two or more vehicles in a geographic region. For example, accounting for the time lapse in FIGS. 3 and 4, the indicator of vehicle 104 can be analyzed with indicators from vehicle 106A, vehicle 106C, and vehicle 106E. Flow then proceeds to block 512.

At block 512, the cooperative adaptive controller determines existence of an external condition based on the analyzed indicators of block 510. For example, cooperative adaptive controller determines existence of the external condition of pothole 308 based on analyzed indicators from vehicles 104, 106A, 106C, and 106E from FIGS. 3 and 4. Although the operation at block 512 determines the external condition is a pothole, embodiments of the corroborative adaptive controller can determine various external conditions including road hazards (e.g., slick roads, bumpy roads, obstructions), weather conditions (e.g., wind, ice, rain, etc.), etc. Flow then proceeds to block 514.

At block 514, the cooperative adaptive controller detects other vehicles in the geographic region. The vehicles detected may be in proximity to the geographic location of the indicators, within the geographic region and approaching the geographic location, or outside the geographic region and approaching the geographic location. For example, cooperative adaptive controller 102 can detect vehicles 106A and B (see FIG. 3). Flow then proceeds to block 516.

At block 516, the cooperative adaptive controller sends an alert indicating the external condition. In some embodiments, the cooperative adaptive controller sends the alert to vehicles in the geographic region. From block 516, flow ends.

The blocks 502-516 shown in FIG. 5 can be performed in other embodiments. For example, an embodiment of the method may utilize land-based components to broadcast alerts to a geographic region without detecting vehicles. The transmission of the alert may be unidirectional from a land-based communication ports to the vehicles, and may depend upon the presence of vehicles in the geographic region.

Additionally, the method and system can receive indicators from vehicles through communication ports strategically geographically placed along roadways, such as communication port 304 in FIGS. 3 and 4. In some embodiments, land-based components can receive the indicators of the first and second vehicles before geographic locations and regions are determined, if at all. It is possible for a land-based corroborative adaptive controller to receive the indicators from the vehicles and broadcast alerts to a predetermined geographic region based on the known geographic location of the communication ports. Thus, the operations for determining a geographic location and region would not be needed. Other embodiments and alternative methods and systems exist and are within the scope of the disclosed method and system.

### Hardware and Operating Environment

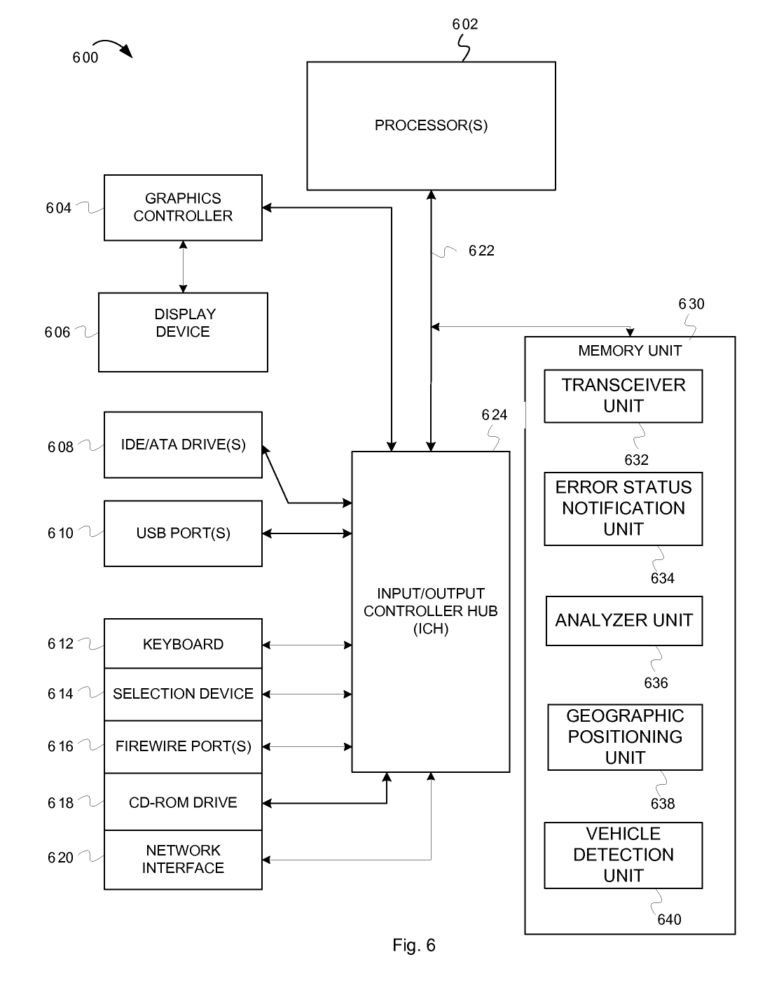

FIG. 6 depicts an example computer system that may embody a cooperative adaptive controller according to an illustrative embodiment of the invention. Computer system 600 includes processor(s) 602. Computer system 600 also includes memory unit 630, processor bus 622, and Input/Output Controller Hub (ICH) 624. Processor(s) 602, memory unit 630, and ICH 624 are coupled to processor bus 622. Processor(s) 602 may include multiple processors, multiple cores, multiple nodes, and/or implementing multi-threading, etc. Memory unit 630 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more realizations of machine-readable media. Processor bus 622 may be PCI, ISA, PCI-Express, HyperTransport®, InfiniBand®, NuBus, etc. The computer system 600 also includes network interface 620 (e.g., an Ethernet interface, a Frame Relay interface, SONET interface, wireless interface, etc.).

ICH 624 provides an interface to I/O devices or peripheral components for computer system 600. ICH 624 may comprise any suitable interface controller to provide for any suitable communication link to processor(s) 602, memory unit 630 and/or to any suitable device or component in communication with ICH 624. For one embodiment of the invention, ICH 624 provides suitable arbitration and buffering for each interface.

For one embodiment of the invention, ICH 624 provides an interface to one or more suitable integrated drive electronics (IDE) drives 608, such as a hard disk drive (HDD) or compact disc read only memory (CD ROM) drive, or to suitable universal serial bus (USB) devices through one or more USB ports 610. For one embodiment, ICH 624 also provides an interface to keyboard 612, selection device 614 such as a mouse, a CD-ROM drive 618, and one or more suitable devices through one or more firewire ports 616. For one embodiment of the invention, ICH 624 also provides network interface 620 though which the computer system 600 may communicate with other computers and/or devices. ICH 624 also provides an interface to graphics controller 604 that controls the display of information on display device 606.

Memory unit 630 embodies functionality to implement the embodiments described above. Memory unit 630 may include one or more functionality that facilitates peer-to-peer, client-server, or a combination thereof, vehicle adaptation to external conditions using analyses of indicators from vehicles in a geographic region. Memory unit 630 may include transmission unit 632, error status notification unit 634, analyzer unit 636, geographic positioning unit 638, and vehicle detection unit 640 to facilitate the functionality described herein. Some or all of the functionality of a corroborative adaptive controller according to illustrative embodiments may be implemented with code embodied in memory unit 630 and/or processor(s) 602. Any one of these functionalities may be partially (or entirely) implemented in hardware and/or on processor(s) 602. For example, the functionality may be implemented with an application specific integrated circuit, in logic implemented in processor(s) 602, in a co-processor on a peripheral device or card, etc. Further, realizations may include fewer or additional components not illustrated in FIG. 6 (e.g., video cards, audio cards, additional network interfaces, peripheral devices, etc.). The processor(s) 602, the storage device(s), and network interface 620 are coupled to bus 622. Although illustrated as being coupled to bus 622, memory unit 630 may be coupled to processor(s) 602.

### General Comments

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

In general, techniques for vehicle adaptation through determination of external conditions by analyses of fault indicators of vehicles, as described herein, may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for determining conditions external to one or more vehicles in a geographic region, the method comprising the steps of:
receiving, in a corroborative adaptive controller, a first group of one or more indicators, wherein the first group of indicators indicate information about one or more subsystems of a first vehicle;
receiving, in the corroborative adaptive controller, a second group of one or more indicators, wherein the second group of indicators indicate information about one or more subsystems of a second vehicle; and
determining, by the corroborative adaptive controller, based on the first group of indicators and the second group of indicators, that there is an external condition in a geographic region including the first vehicle and the second vehicle that can affect performance of the first vehicle and the second vehicle.

2. The method of claim 1, wherein the external condition is a road hazard.

3. The method of claim 1, wherein the first and second groups of indicators indicate faults of the first and second vehicles.

4. The method of claim 1 further comprising:
determining a geographic location associated with the external condition, wherein the geographic location resides within the geographic region;
detecting a third vehicle approaching the geographic location associated with the external condition; and
sending an alert regarding the external condition to the third vehicle.

5. The method of claim 1 further comprising:
determining a geographic location for each of the indicators in the first and second groups, wherein the external condition is associated with the geographic location.

6. A computer system comprising one or more processors, one or more computer-readable memories, one or more computer-readable, tangible storage devices and program instructions which are stored on the one or more storage devices for execution by the one or more processors via the one or more memories and when executed by the one or more processors perform the method of claim 1.

7. A computer program product comprising one or more computer-readable, tangible storage devices and computer-readable program instructions which are stored on the one or more storage devices and when executed by one or more processors, perform the method of claim 1.

8. A computer program product for determining conditions external to one or more vehicles, the computer program product comprising:
one or more computer-readable, tangible storage devices;
program instructions, stored on at least one of the one or more storage devices, to receive a first group of one or more indicators, wherein the first group of indicators indicate information about one or more subsystems of a first vehicle;
program instructions, stored on at least one of the one or more storage devices, to receive a second group of one or more indicators, wherein the second group of indicators indicate information about one or more subsystems of a second vehicle, wherein the first and second vehicles are located within a geographic region; and
program instructions, stored on at least one of the one or more storage devices, to determine, based on the first group of indicators and the second group of indicators, that there is an external condition in the geographic region that can affect performance of the first vehicle and the second vehicle.

9. The computer program product of claim 8, wherein the external condition is a road hazard.

10. The computer program product of claim 8, wherein the first and second groups of indicators indicate faults of the first and second vehicles.

11. The computer program product of claim 8 further comprising:
program instructions, stored on at least one of the one or more storage devices, to determine a geographic location associated with the external condition, wherein the geographic location resides within the geographic region;
program instructions, stored on at least one of the one or more storage devices, to detect a third vehicle approaching the geographic location associated with the external condition; and
program instructions, stored on at least one of the one or more storage devices, to send an alert regarding the external condition to the third vehicle.

12. The computer program product of claim 8 further comprising program instructions, stored on at least one of the one or more storage devices, to determine a geographic location for each of the indicators in the first and second groups, wherein the external condition is associated with the geographic location.

13. The computer program product of claim 8 further comprising program instructions, stored on at least one of the one or more storage devices, to send an alert identifying the external condition to all vehicles in the geographic region.

14. The computer program product of claim 8 further comprising program instructions, stored on at least one of the one or more storage devices to send an alert about the external condition to a transportation authority.

15. A computer system for determining conditions external to one or more vehicles in a geographic region, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories, to receive a first group of one or more indicators, wherein the first group of indicators indicate information about one or more subsystems of a first vehicle;
program instructions, stored on at least one of the one or more storage devices for execution by at least one of the one or more processors via at least one of the one or more memories, to receive a second group of one or more indicators, wherein the second group of indicators indicate information about one or more subsystems of a second vehicle, wherein the first and second vehicles are located within a geographic region; and
program instructions, stored on at least one of the one or more storage devices for execution by at least one of the one or more processors via at least one of the one or more memories, to determine, based on the first group of indicators and the second group of indicators, that there is an external condition that can affect performance of the first vehicle and the second vehicle.

16. The computer system of claim 15, wherein the external condition is a road hazard.

17. The computer system of claim 15, wherein the first and second groups of indicators indicate faults of the first and second vehicles.

18. The computer system of claim 15 further comprising:
program instructions, stored on at least one of the one or more storage devices for execution by at least one of the one or more processors via at least one of the one or more memories, to determine a geographic location associated with the external condition, wherein the geographic location resides within the geographic region;
program instructions, stored on at least one of the one or more storage devices for execution by at least one of the one or more processors via at least one of the one or more memories, to detect a third vehicle approaching the geographic location associated with the external condition; and
program instructions, stored on at least one of the one or more storage devices for execution by at least one of the one or more processors via at least one of the one or more memories, to send an alert regarding the external condition to the third vehicle.

19. The computer system of claim 15 further comprising:
program instructions, stored on at least one of the one or more storage devices for execution by at least one of the one or more processors via at least one of the one or more memories, to determine a geographic location for each of the indicators in the first and second groups, wherein the external condition is associated with the geographic location.

20. The computer system of claim 15 further comprising:
program instructions, stored on at least one of the one or more storage devices for execution by at least one of the one or more processors via at least one of the one or more memories, to send an alert identifying the external condition to all vehicles in the geographic region.
